(19) United States
(12) Patent Application Publication
(10) Pub. No.: US 2014/0327592 A1
(43) Pub. Date: Nov. 6, 2014

(54) ANTENNA STRUCTURE AND WIRELESS COMMUNICATION DEVICE EMPLOYING SAME

(71) Applicant: FIH (Hong Kong) Limited, Kowloon (HK)

(72) Inventors: CHIH-YANG TSAI, Shindian (TW); CHUAN-CHOU CHI, New Taipei (TW); CHENG-HUNG KO, Shindian (TW); HAO-YING CHANG, Shindian (TW)

(73) Assignee: FIH (Hong Kong) Limited, Kowloon (HK)

(21) Appl. No.: 14/069,379

(22) Filed: Nov. 1, 2013

(30) Foreign Application Priority Data
May 3, 2013 (TW) 102115915

(51) Int. Cl. H01Q 1/52

(52) U.S. Cl. CPC H01Q 1/526
USPC 343/841

(57) ABSTRACT

An antenna structure includes an antenna and a metal member located between the antenna and an electronic member. The antenna is configured for receiving and sending wireless signals. An electrical length of the metal member is greater than or equal to a quarter wavelength of a resonance frequency band of the antenna. The metal member transmits wireless signals generated by the electronic member to ground to prevent signals generated by the electronic member from interfering with the antenna.

### BACKGROUND

1. Technical Field

The disclosure generally relates to antenna structures, and particularly to an antenna structure capable of blocking interference signals and a wireless communication device employing the antenna structure.

2. Description of Related Art

A wireless communication device includes a printed circuit board and electronic components, such as a battery or a camera. The printed circuit board (PCB) has an antenna which requires a large clearance area to prevent wireless signals generated by the electronic components from interfering with the antenna. However, the large clearance area compromises efforts toward miniaturization of wireless communication devices employing the antenna.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 is an isometric view of a wireless communication device employing an embodiment of an antenna structure.

FIG. 2 is an exploded view of the wireless communication device shown in FIG. 1.

FIG. 3 is an enlarged view of part of the communication device shown in FIG. 1.

FIG. 4 is an enlarged view of an antenna of the antenna structure shown in FIG. 1.

FIG. 5 is a diagram showing voltage standing wave ratio (VSWR) measurements of the antenna structure of FIG. 4.

FIG. 6 is a diagram showing radiation efficiency measurements of the antenna structure of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

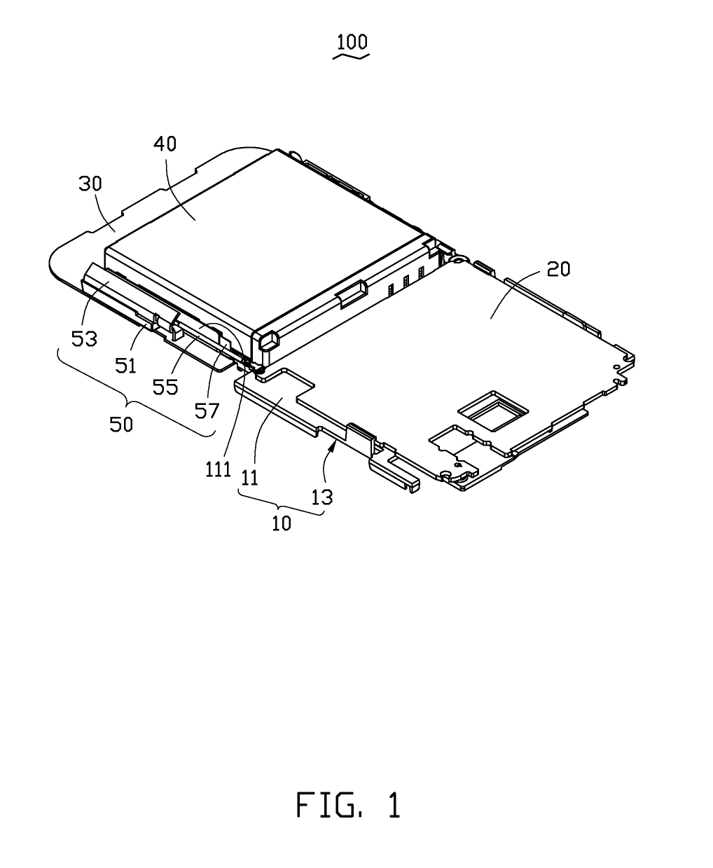

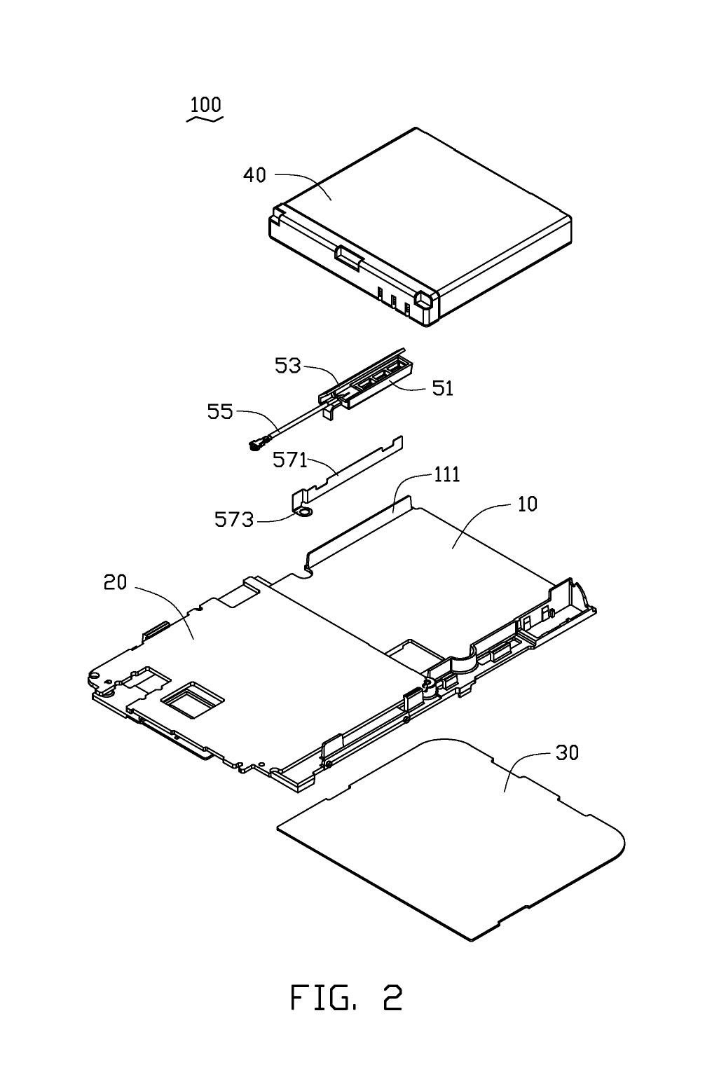

FIG. 1 and FIG. 2 show a wireless communication device 100 employing an embodiment of an antenna structure 50. The wireless communication device 100 further includes a supporting member 10, a motherboard 20, a sub-board 30, an electronic member 40, and the antenna structure 50. The motherboard 20, the sub-board 30, the electronic member 40, and the antenna structure 50 are mounted on the supporting member 10.

The supporting member 10 is made of dielectric material such as plastic. The supporting member 10 includes a first surface 11 and an opposite second surface 13. The supporting member 10 has a sidewall 111 protruding from the first surface 11.

The motherboard 20 and the electronic member 40 are mounted on the first surface 11 and are spaced apart from each other. The sub-board 30 is mounted on the second surface 13. The sub-board 30 is electronically connected to the motherboard 20 via a flexible printed circuit (FPC) or bridging members (not shown). The electronic member 40 is located at a first side of the sidewall 111. In one embodiment, the electronic member 40 is a battery pack. In other embodiments, the electronic member 40 is a camera or an electronic component that outputs wireless signals that interfere with antennas.

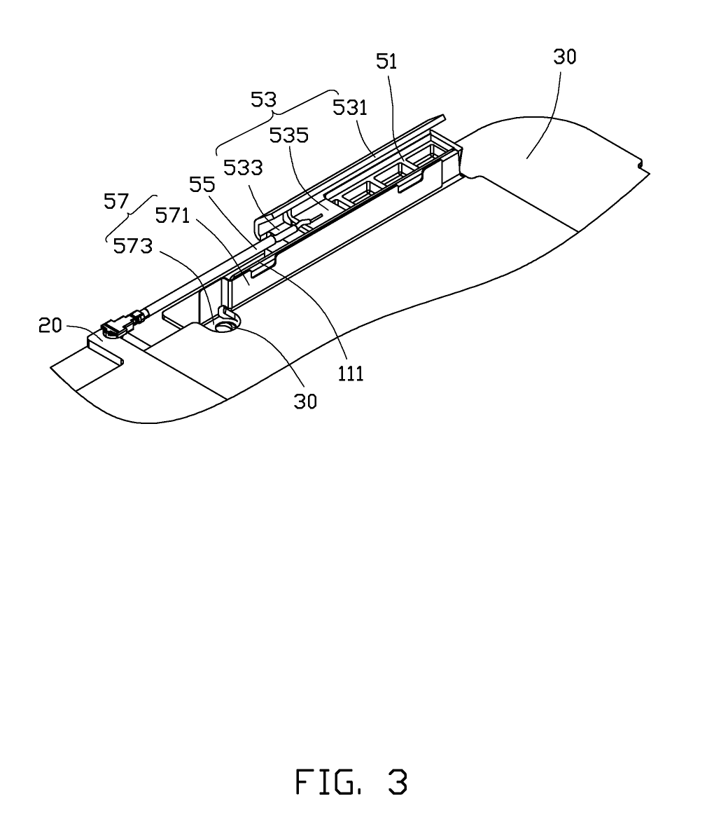

FIG. 3 shows that the antenna structure 50 includes a holder 51, an antenna 53, a feeding cable 55, and a metal member 57. The holder 51 is mounted on the supporting member 10 and is located at a second side of the sidewall 111 away from the electronic member 40. The antenna 53 is located on the holder 51.

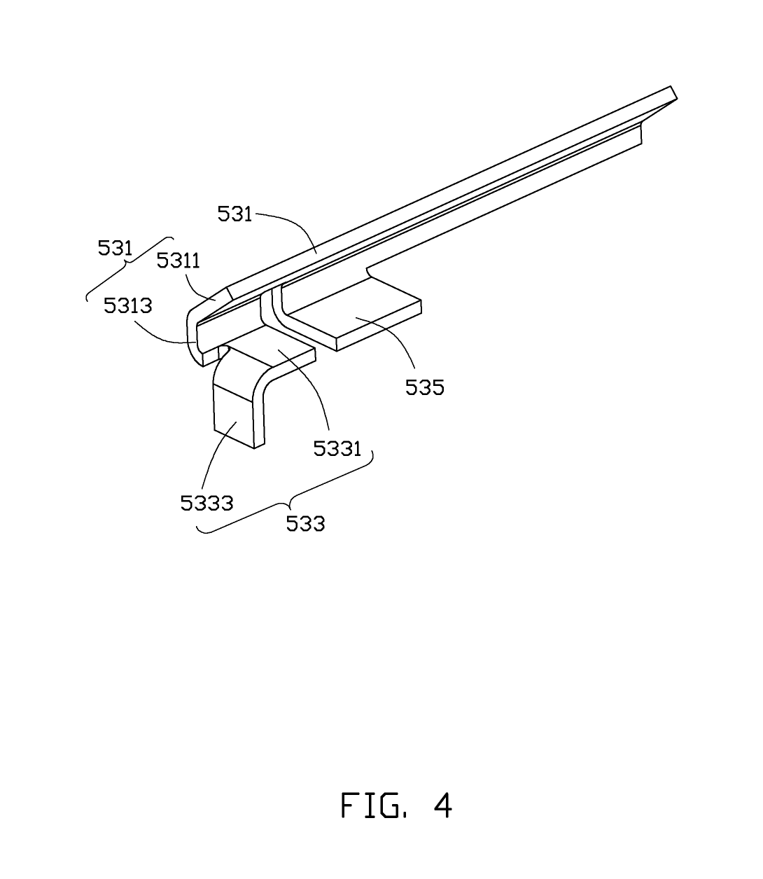

FIG. 4 shows that the antenna 53 includes a radiating portion 531, a grounding portion 533, and a feeding portion 535. The radiating portion 531 receives and sends wireless signals. The grounding portion 533 is ground. The feeding portion 535 feeds current signals to the antenna 53. In one embodiment, the radiation portion 531 includes a first section 5311 and a second section 5313. The first section 5311 is a substantially rectangular sheet. The second section 5313 is connected to the first section 5311 and forms an obtuse angle with the first section 5311. The grounding portion 533 and the feeding portion 535 extend from a same side of the second section 5313. The grounding portion 533 and the feeding portion 535 are spaced from each other. The grounding portion 533 includes a first grounding arm 5331 and a second grounding arm 5333. The first grounding arm 5331 extends from the second section 5313. The second grounding arm 5333 extends substantially perpendicularly from a side of the first grounding arm 5331 away from the radiation portion 531. A distal end of the second grounding arm 5333 is connected to the sub-board 30. Thus, the grounding portion 533 is ground via the sub-board 30. The feeding portion 535 is a substantially planar sheet and is coplanar with the first grounding arm 5331.

The feeding cable 55 is electronically connected between the feeding portion 535 and the motherboard 20 (see FIG. 3). The motherboard 20 outputs the current signals to the feeding portion 535 via the feeding cable 55.

Referring also to FIG. 1 and FIG. 3, the metal member 57 is located between the electronic member 40 and the antenna 53. The metal member 57 is ground. Thus, the metal member 57 transmits wireless signals generated by the electronic member 40 to ground, thereby preventing the wireless signals of the electronic member 40 from interfering with the antenna 53. In addition, an electrical length of the metal member 57 is greater than or equal to a quarter wavelength of a resonance frequency band, such as 2.4 gigahertz (GHz), of the antenna 53. Thus, the metal member 57 does not resonate with the antenna 53, which improves a radiation efficiency of the antenna 53.

In one embodiment, the metal member 57 includes a main body 571 and a grounding portion 573 extending from a distal end of the main body 571 (see FIG. 3). The main body 571 can be located at either the first side of the sidewall 111 facing the electronic member 40 or the second side of the sidewall 111 facing the antenna 53. In one embodiment, the metal member 57 is located at the first side of the sidewall 111. For example, a distance between the metal member 57 and the electronic member 40 is about 2.5 millimeters (mm), and a distance between the metal member 57 and the antenna 53 is about 2 mm. The grounding portion 573 is located on the sub-board 30, and the grounding portion 573 is ground via the sub-board 30. In one embodiment, the grounding portion 573 is substantially perpendicular to the main body 571. The metal member 57 is made of metal, such as copper, iron, or aluminum.

In another embodiment, the sub-board 30 can be omitted, such that the metal member 57 is ground via the motherboard 20.

In one embodiment, the antenna 53 receives/sends wireless signals at a frequency of about 2.4 GHz. In another embodiment, the antenna 53 is a multiband antenna, such that an electrical length of the metal member 57 is greater than or equal to a quarter wavelength of a minimum resonance frequency band of the antenna 53.

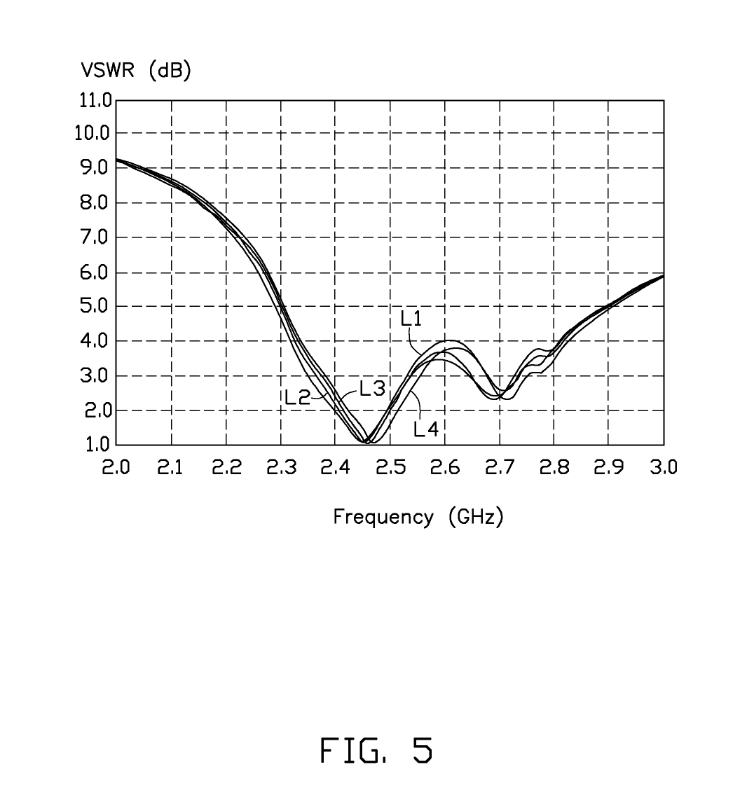

FIG. 5 is a diagram showing a voltage standing wave ratio (VSWR) measurement of the antenna structure 50. Curves L1-L4 refer to different VSWR curves corresponding to four different electronic members 40, such as four different batteries, mounted to the wireless communication device 100. FIG. 5 shows that the curves L1-L4 have a central frequency band at about 2.4 GHz. In other words, presence of the metal member 57 allows the antenna 53 to normally receive and transmit signals when different electronic members 40 are used.

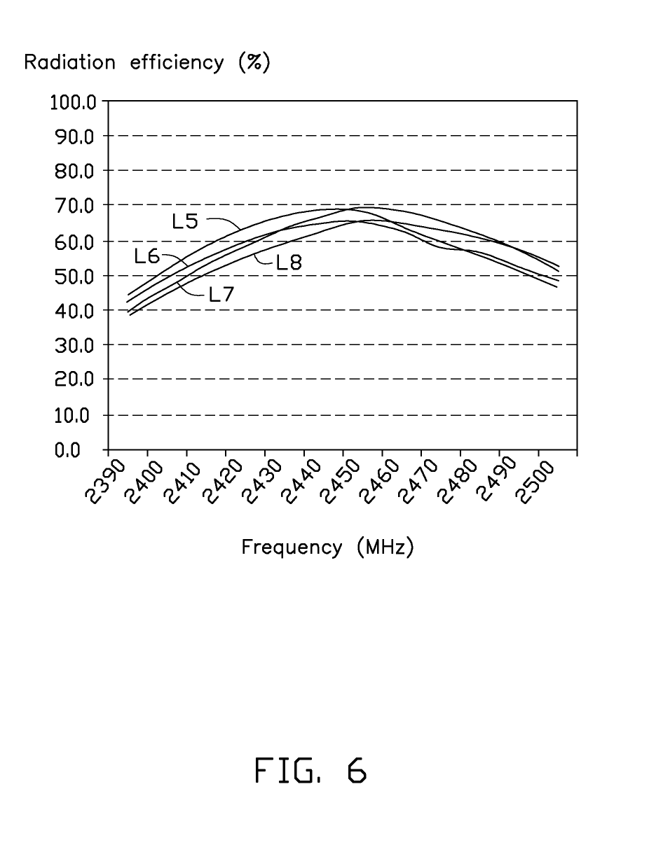

FIG. 6 is a diagram showing radiation efficiency measurements of the antenna structure 50 when different electronic members 40 are used. Curves L5-L8 refer to different radiation efficiency curves corresponding to four different electronic members 40, such as four different batteries, mounted to the wireless communication device 100. As shown in FIG. 6, the antenna 53 is capable of receiving and transmitting wireless signals at a radiation efficiency greater than about 50% when using each electronic member 40. In addition, table 1 shows radiation efficiency measurements of the antenna structure 50 when the metal member 57 is used and when the metal member 57 is not used. As shown in table 1, regarding the same electronic member 40, the radiation efficiency of the antenna structure 50 at a frequency band of about 204 GHz to about 2.5 GHz is higher when the metal member 57 is used.

TABLE 1

| Frequency | radiation efficiency when the | radiation efficiency when the |
|---|---|---|
| (MHz) | metal member is not used (%) | metal member is used (%) |
| 2400 | 49.95 | 51.69 |
| 2410 | 57.14 | 58.51 |
| 2420 | 61.23 | 63.01 |
| 2430 | 64.43 | 66.85 |
| 2440 | 64.83 | 68.39 |
| 2450 | 62.08 | 68.29 |
| 2460 | 55.90 | 64.01 |
| 2470 | 48.75 | 58.81 |
| 2480 | 41.39 | 55.98 |
| 2490 | 34.85 | 51.45 |
| 2500 | 28.46 | 47.02 |

It is believed that the embodiments and their advantages will be understood from the foregoing description, and it will be apparent that various changes may be made thereto without departing from the spirit and scope of the disclosure or sacrificing all of its material advantages, the examples hereinbefore described merely being embodiments of the disclosure.

What is claimed is:

1. An antenna structure, comprising:
an antenna configured for receiving and sending wireless signals; and
a metal member located between the antenna and an electronic member; wherein an electrical length of the metal member is greater than or equal to a quarter wavelength of a resonance frequency band of the antenna, the metal member is configured to transmit wireless signals generated by the electronic member to ground.

2. The antenna structure of claim 1, wherein the metal member comprises a main body and a grounding portion extending substantially perpendicularly from a distal end of the main body, the grounding portion is grounded, and the grounding portion is positioned in a plane that is substantially perpendicular to a plane in which the main body is positioned.

3. The antenna structure of claim 1, wherein the antenna comprises a radiation portion, a grounding portion, and a feeding portion, and the grounding portion and the feeding portion extend from one side of the radiation portion and are spaced from each other.

4. The antenna structure of claim 3, wherein the radiation portion comprises a first section and a second section, the first section is a substantially rectangular sheet, and the second section is connected to the first section and forms an obtuse angle with the first section.

5. The antenna structure of claim 4, wherein the grounding portion comprises a first grounding arm and a second grounding arm, the first grounding arm extends from a side of the section and is coplanar with the feeding portion, and the second grounding arm extends substantially perpendicularly from the first radiation arm away from the radiation portion.

6. A wireless communication device, comprising an electronic member and an antenna structure, the antenna structure comprising:
an antenna configured for receiving and sending wireless signals; and
a metal member located between the antenna and the electronic member, wherein an electrical length of the metal member is larger than or equal to a quarter wavelength of a resonance frequency band of the antenna, and the metal member transmits wireless signals generated by the electronic member to ground.

7. The wireless communication device of claim 6, wherein the metal member comprises a main body and a grounding portion extending substantially perpendicularly from a distal end of the main body, the grounding portion is grounded, and the grounding portion is positioned in a plane that is substantially perpendicular to a plane in which the main body is positioned.

8. The wireless communication device of claim 6, wherein the antenna comprises a radiation portion, a grounding portion, and a feeding portion, and the grounding portion and the feeding portion extend from one side of the radiation portion and are spaced from each other.

9. The wireless communication device of claim 8, wherein the radiation portion comprises a first section and a second section, the first section is a substantially rectangular sheet, and the second section is connected to the first section and forms an obtuse angle with the first section.

10. The wireless communication device of claim 9, wherein the grounding portion comprises a first grounding arm and a second grounding arm, the first grounding arm extends from a side of the section and is coplanar with the feeding portion, and the second grounding arm extends substantially perpendicularly from the first radiation arm away from the radiation portion.

11. The wireless communication device of claim 6, further comprising a supporting member, the supporting member comprises a sidewall, and the electronic member and the antenna are mounted on the supporting member, and are located at two opposite sides of the sidewall respectively.

12. The wireless communication device of claim 11, wherein the metal member is mounted at a surface of the sidewall facing the electronic member.
